(19) United States
(12) Patent Application Publication
(10) Pub. No.: US 2013/0234464 A1
(43) Pub. Date: Sep. 12, 2013

(54) SEAT ATTACHMENT DEVICE IN A MOTOR VEHICLE AND METHOD FOR INSTALLING A SECOND ROW OF SEATS

(71) Applicant: GM GLOBAL TECHNOLOGY OPERATIONS LLC, Detroit, MI (US)

(72) Inventors: Harald CZERWENSKI, Ruesselsheim (DE); Stefan GLOGER, Muehltal (DE)

(73) Assignee: GM GLOBAL TECHNOLOGY OPERATIONS LLC, Detrolt, MI (US)

(21) Appl. No.: 13/785,697

(22) Filed: Mar. 5, 2013

(30) Foreign Application Priority Data
Mar. 8, 2012 (DE) 10 2012 004 824.6

(51) Int. Cl. B60N 2/06; B62D 65/14

(52) U.S. Cl. CPC B60N 2/06; B62D 65/14
USPC 296/65.13; 29/428

(57) ABSTRACT

A seat attachment device in a motor vehicle with a first row of seats and a second row of seats is provided. The seat attachment device includes at least two longitudinal rails adjacent to each other in the traveling direction, which are suitable for establishing a connection with a vehicle floor on their lower side and accommodating at least one seat element of the second row of seats on their upper side. The longitudinal rails each exhibit a recess suitable for accommodating a cross member lying transverse to the traveling direction. Also provided is a method for installing a second row of seats.

### CROSS-REFERENCE TO RELATED APPLICATION

This application claims priority to German Patent Application No. 10 2012 004 824.6, filed Mar. 8, 2012, which is incorporated herein by reference in its entirety.

### TECHNICAL FIELD

The technical field relates to a seat attachment device in a motor vehicle, in particular to a seat attachment device in a motor vehicle with a third row of seats. In addition, the technical field relates to a method for installing a second row of seats.

### BACKGROUND

As known, certain motor vehicles are equipped with several rows of seats, so as to offer room to the highest number of passengers possible. To this end, a second, and in some motor vehicles even a third, row of seats is arranged behind a front row of seats. The third row of seats is either installed as a permanent row of seats, or as a foldable arrangement can offer additional space as needed.

One example for a motor vehicle with a third row of seats designed as foldable emergency seats is known from DE 10340494 B4.

Seats or rows of seats in motor vehicles are typically mounted on so-called cross members. The cross members are formed in the vehicle floor by rectangular profiles, so-called bars. These are consecutively numbered in the traveling direction. In vehicles with three rows of seats, the fourth cross structure typically lies at the front edge of the second row of seats.

This yields a tiered arrangement of the vehicle floor, starting with a deep position in the first row of seats and extending to a clearly elevated position in the third row of seats. For example, this may be discerned from FIG. 3 of the publication cited above.

Since the seat surfaces are unable to offset this rise due to a horizontal or most often even rearward sloping roofline and the resultant free space above the head for the passenger, the distance between the hip point and heel point, which is defined as the so-called sitting height, increasingly diminishes toward the third row of seats, thus becoming more uncomfortable for the passengers.

In addition, other objects, desirable features and characteristics will become apparent from the subsequent summary and detailed description, and the appended claims, taken in conjunction with the accompanying drawings and this background.

### SUMMARY

According to various aspects of the present disclosure, provided is an alternative attachment for the second row of seats, so as to at least partially surmount the disadvantages mentioned above.

Provided according to the present disclosure is a seat attachment device in a motor vehicle with a first row of seats and a second row of seats, which encompasses at least two longitudinal rails adjacent to each other in the traveling direction. The longitudinal rails are suitable for establishing a connection with a vehicle floor on their lower side, and accommodating at least one seat element of the second row of seats on their upper side. The longitudinal rails each exhibit a recess suitable for accommodating a cross member lying transverse to the traveling direction.

As a result, the tiered floor structure prevailing in prior art is phased out by arranging a cross member above the seat rails of the second row of seats. In order to retain the seat height in the middle row of seats and permit longitudinal adjustment, the seat surface and seat rails have installed between them longitudinal rails with recesses, through which the cross member is inserted. This yields an overall improvement in seating comfort for the rear passengers in vehicles with three rows of seats. However, it also simplifies the assembly of the second row of seats through a modular structure, thereby integrating the individual seats on the cross member.

According to another exemplary embodiment, the seat element is a bench seat.

The present disclosure can also be applied to a seat bench, since the seating comfort of the rear passengers can here also be improved in vehicles with three rows of seats.

According to another exemplary embodiment, two or three seat elements are provided as individual seats.

In addition to improving the seating comfort for the rear passengers in vehicles with three rows of seats, installation can also be simplified.

According to another exemplary embodiment, the dimensions of the recess are such that the connection between the two longitudinal rails adjacent to each other in the traveling direction and the vehicle floor can be adjusted in the traveling direction.

The recesses in the cross member must be large enough not to limit the necessary structural cross section of the cross member, while at the same time allowing for a seat adjustment track.

According to another exemplary embodiment, the adjustable connection between the longitudinal rails and vehicle floor takes the form of a sliding rail.

A sliding rail makes it easy to adjust the second row of seats.

According to another exemplary embodiment, the cross member can be connected with the sliding rail by means of a detachable fixation, so that the second row of seats can be installed in a single operation.

For example, the detachable fixation can be established by means of erection screws or bolts, which can again be detached following assembly, so as to enable the desired adjustability.

According to another exemplary embodiment, a third row of seats is additionally provided, wherein the cross member is arranged in such a way as to yield an unobstructed foot well between the second and third row of seats.

Also indicated is the use of a seat attachment device described above in a motor vehicle that exhibits a second row of seats and a third row of seats, wherein a vehicle floor of the motor vehicle has a flat design up until the third row of seats.

The method according to the present disclosure for installing a second row of seats in a motor vehicle having a first row of seats involves providing two longitudinal rails, and providing several seat elements. The method also includes providing a cross member and inserting the cross member through the longitudinal rails. The method also includes arranging the seat element on the upper side of the longitudinal rails, and establishing a connection between the cross member, the longitudinal rails and the seat elements, so as to form a preassembled second row of seats. The method further comprises introducing the preassembled second row of seats into the motor vehicle.

The insertion of a cross rail through the seat structure advantageously changes the assembly sequence, which simultaneously offers the chance of introducing the complete second row of seats, which can be made up of several individual seats, together with the cross rail into the vehicle as a module, to thereby simplify the installation process. The seats can here be combined with the cross rail in a fixed position, wherein this connection is disengaged after introduction into the vehicle, so as to from that point allow the longitudinal adjustment of the seats.

In another exemplary embodiment, the lower side of the longitudinal rails is joined with a respective sliding rail, which enables an adjustment of the second row of seats in the installed state, wherein the sliding rails are fixed to the cross member during assembly.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a sectional view depicting an exemplary embodiment of a seat attachment device according to the present disclosure in a vehicle;

FIG. 2 is a sectional view depicting a comparative example for a seat attachment device in a motor vehicle; and

FIG. 3 is a flowchart illustrating a method according to the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Identical or functionally equivalent components on the figures are marked with the same reference numbers.

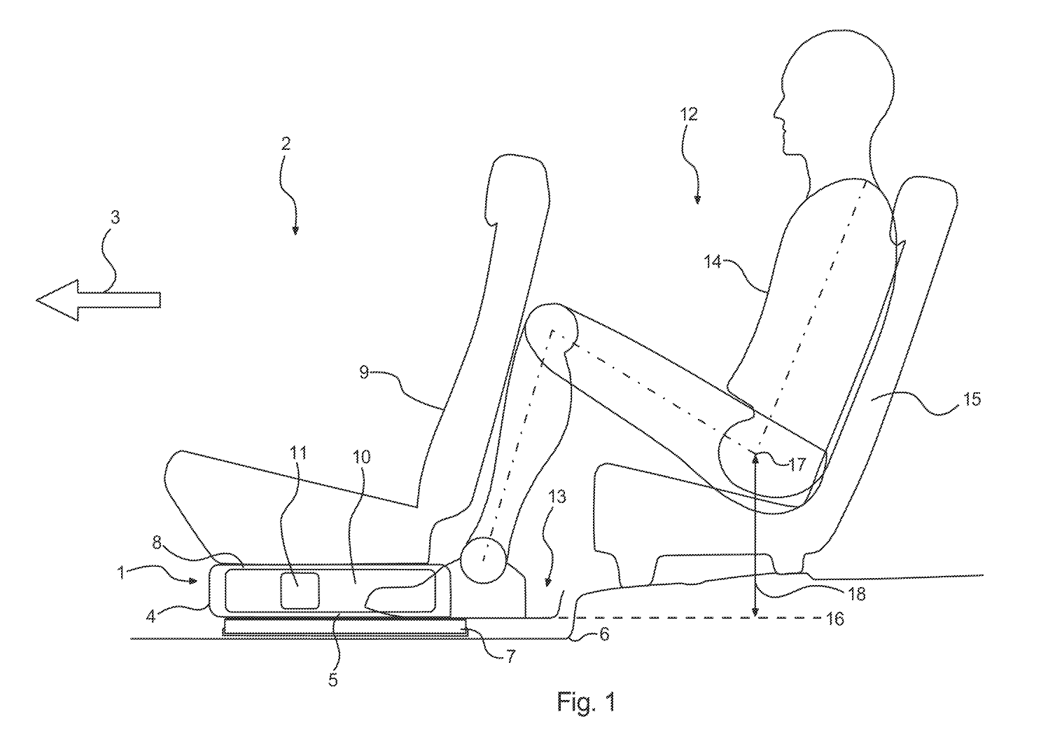

FIG. 1 depicts a seat attachment device 1 that is secured in a motor vehicle. The motor vehicle exhibits a first row of seats (not shown on FIG. 1), which usually includes a driver's and front passenger seat. The seat attachment device 1 is provided for a second row of seats 2, which viewed in the traveling direction 3 is arranged behind the first row of seats. The seat attachment device 1 encompasses at least two longitudinal rails 4 that are adjacent to each other in the traveling direction 3.

The longitudinal rails are connected on their lower side 5 with a vehicle floor 6. As illustrated on FIG. 1, this can take place by way of a respective sliding rail 7, which enables an adjustment of the second row of seats 2 in or opposite the traveling direction 3. However, it is equally conceivable to use the teachings of the present disclosure in rigidly mounted rows of seats 2.

The longitudinal rails 4 are connected on their upper side 8 with a seat element 9 of the second row of seats 2. The seat element 9 can either be a seat bank or take the form of individual seats, which can also each exhibit their own sliding mechanism, e.g., one involving the sliding rails 7.

The longitudinal rails 4 each exhibit a recess 10. A cross member 11 lying transverse to the traveling direction 3 is secured in the recess.

The dimensions of the recess 10 are such that the connection between the two longitudinal rails 4 adjacent to each other in the traveling direction and the vehicle floor 6 can be adjusted in the traveling direction. The recesses 10 in the longitudinal rails 4 must be large enough not to limit the necessary structural cross section of the cross member 11, while at the same time allowing for a seat adjustment track.

In addition, a third row of seats 12 is provided behind the second row of seats 2, wherein the cross member 11 is arranged in such a way as to yield as unobstructed a foot well 13 as possible between the second row of seats 2 and third row of seats 12. For example, this can be achieved by situating the cross member 11 far enough toward the front in the traveling direction 3 as to not pose an obstacle in the foot well 13.

An overall improvement in seating comfort is achieved for the rear passengers 14 on seats 15 in the third row of seats. However, the assembly of the second row of seats 2 is also simplified through a modular structure, thereby integrating the individual seats on the cross member 11. The distance 18 between the hip point 17 and heel point 16, which is defined as the so-called sitting height, hence no longer diminishes toward the third row of seats, and is thus comfortable for the passengers 14.

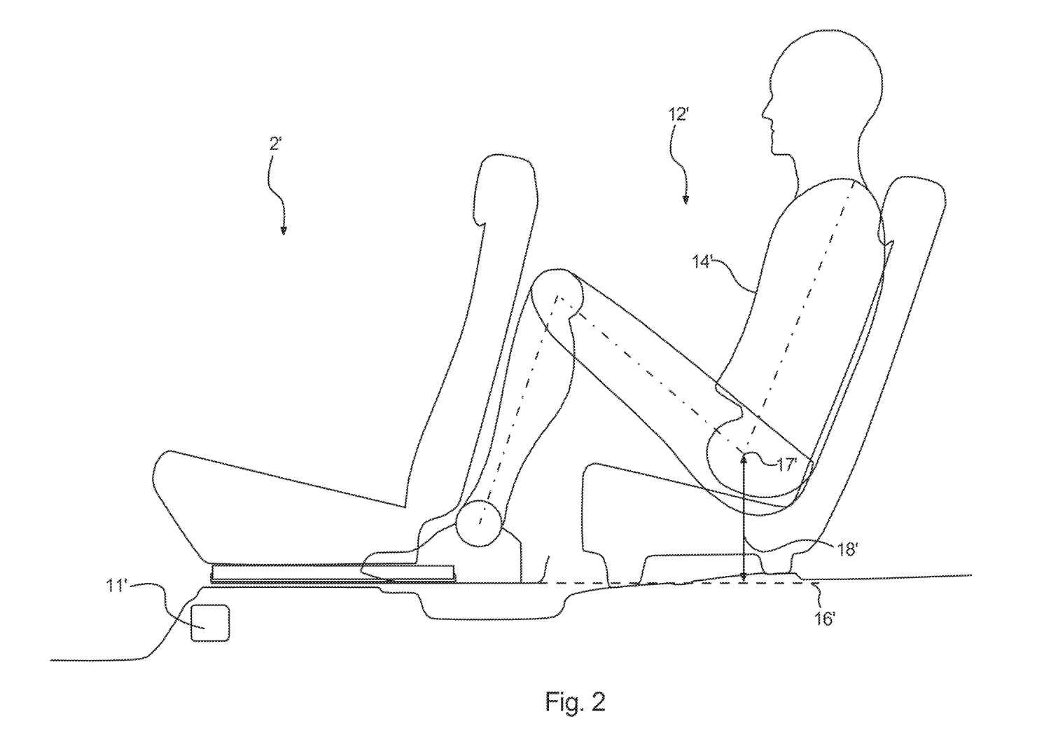

This is made clear in particular by a comparison to a tiered floor structure encountered in prior art, which is depicted on FIG. 2. As evident, the distance 18′ between the hip point 17′ and heel point 16′ for a passenger 14′ is distinctly smaller. This is caused by the use of a cross rods 11′ under the seats of the second row of seats 2′.

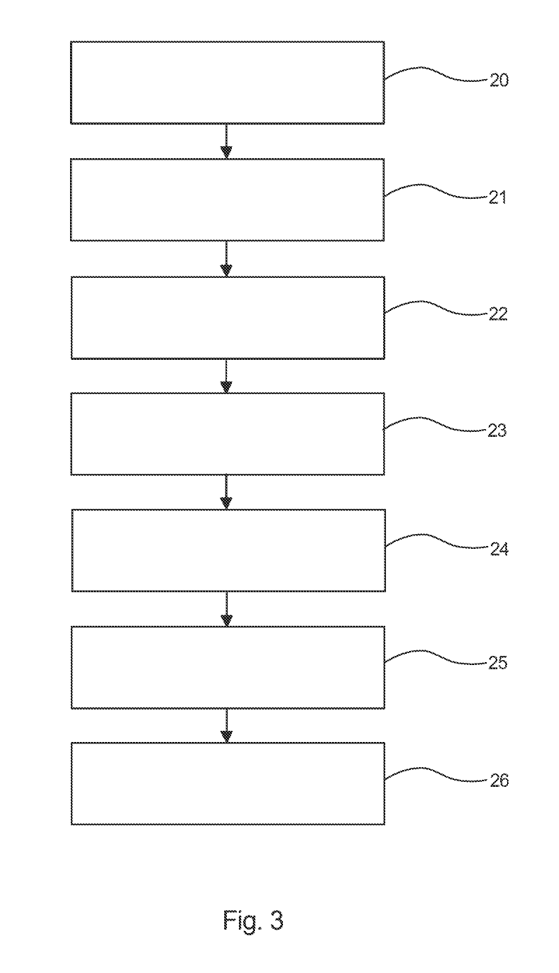

Beyond improving seating comfort, the present disclosure also provides an improved way of installing the second row of seats 2. In a method for mounting the second row of seats 2 in a motor vehicle, the following method described below is performed, drawing reference to FIG. 3.

The two longitudinal rails 4 are prepared in 20. One or more seat elements 9 are prepared in 21. This is followed in 22 by preparing the cross member 11. The cross member 11 is inserted through the recesses 10 of the longitudinal rails 4 in 23. The seat elements 9 are situated on the upper side 8 of the longitudinal rails 4 in 24. A connection is then established between the cross member 11, longitudinal rails 4 and seat elements 9 in 25, so as to form a preassembled second row of seats 2. Finally, the preassembled second row of seats 2 is introduced into the motor vehicle in 26. The lower side 5 of the longitudinal rails 4 can be joined with a respective sliding rail 7, which enables an adjustment of the second row of seats 2 in the installed state, wherein the sliding rails 7 are fixed to the cross member 11 during assembly.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A seat attachment device in a motor vehicle with a first row of seats and a second row of seats, comprising:
at least two longitudinal rails adjacent to each other in a traveling direction, which are suitable for establishing a connection with a vehicle floor on their lower side, and accommodating at least one seat element of the second row of seats on their upper side,
wherein the longitudinal rails each exhibit a recess suitable for accommodating a cross member lying transverse to the traveling direction.

2. The seat attachment device according to claim 1, in which the seat element is a bench seat.

3. The seat attachment device according to claim 1, in which two or three seat elements are provided as individual seats.

4. The seat attachment device according to claim 1, in which the dimensions of the recess are such that the connection between the two longitudinal rails adjacent to each other in the traveling direction and the vehicle floor are adjustable in the traveling direction.

5. The seat attachment device according to claim 4, in which the adjustable connection between the longitudinal rails and vehicle floor takes the form or a sliding rail.

6. The seat attachment device according to claim 5, in which the cross member is connectable with the sliding rail by means of a detachable fixation, so that the second row of seats is installable in a single operation.

7. The seat attachment device according to claim 1, in which a third row of seats is additionally provided, wherein the cross member is arranged in such a way as to yield an unobstructed foot well between the second row of seats and the third row of seats.

8. A motor vehicle, comprising:
a vehicle floor;
a second row of seats having at least one seat element;
a third row of seats; and
a seat attachment device that couples at least one of the second row of seats and third row of seats to the vehicle floor, the seat attachment device including at least two longitudinal rails adjacent to each other in a traveling direction, which are suitable for establishing a connection with the vehicle floor on their lower side, and accommodating the at least one seat element of the second row of seats on their upper side, and the longitudinal rails each exhibit a recess suitable for accommodating a cross member lying transverse to the traveling direction,
wherein a vehicle floor of the motor vehicle has a flat design up until the third row of seats.

9. The motor vehicle according to claim 8, in which the dimensions of the recess are such that the connection between the two longitudinal rails adjacent to each other in the traveling direction and the vehicle floor are adjustable in the traveling direction.

10. The motor vehicle according to claim 9, in which the adjustable connection between the longitudinal rails and vehicle floor takes the form or a sliding rail.

11. The motor vehicle according to claim 10, in which the cross member is connectable with the sliding rail by means of a detachable fixation, so that the second row of seats is installable in a single operation.

12. The motor vehicle according to claim 8, wherein the cross member is arranged in such a way as to yield an unobstructed foot well between the second row of seats and the third row of seats.

13. The motor vehicle according to claim 8, in which the seat element is a bench seat.

14. A method for installing a second row of seats in a motor vehicle having a first row of seats, comprising:
providing two longitudinal rails;
providing at least one seat element;
providing a cross member;
inserting the cross member through the longitudinal rails;
arranging the at least one seat element on the upper side of the longitudinal rails;
establishing a connection between the cross member, the longitudinal rails and the at least one seat element, so as to form a preassembled second row of seats, and
introducing the preassembled second row of seats into the motor vehicle.

15. The method according to claim 14, in which the lower side of the longitudinal rails is joined with a respective sliding rail, which enables an adjustment of the second row of seats in the installed state, wherein the sliding rails are fixed to the cross member during assembly.
